(19) United States
(12) Patent Application Publication
(10) Pub. No.: US 2013/0304241 A1
(43) Pub. Date: Nov. 14, 2013

(54) APPLIANCE CONTROL

(71) Applicant: Kedar Ingale, Cerritos, CA (US)

(72) Inventor: Kedar Ingale, Cerritos, CA (US)

(21) Appl. No.: 13/836,933

(22) Filed: Mar. 15, 2013

Related U.S. Application Data
(60) Provisional application No. 61/646,262, filed on May 12, 2012.

(51) Int. Cl. G05B 15/02

(52) U.S. Cl. CPC G05B 15/02
USPC 700/83

(57) ABSTRACT

An appliance control system includes a user and appliance electronic computing devices in communication through first and second transceivers. An appliance is operatively coupled with the appliance electronic computing device to perform actions commanded by a user through interaction with the user appliance electronic computing device and a coupled display using a remote control. A user interface component is operatively coupled with the user electronic computing device and configured to prepare user command packages from user input. An appliance controller is operatively coupled with the appliance electronic computing device and configured to manage translation of commands to the appliance and issuance of responses from the appliance. The appliance control system may be practiced according to a method for controlling an appliance with the appliance control system and is implemented, in part using a computer program product comprising a series of instructions executable by an electronic computing device.

### CROSS REFERENCE TO RELATED APPLICATIONS

This application claims the priority benefit of U.S. Provisional Application No. 61/646,262 filed on May 12, 2012 which is incorporated herein by reference in its entirety.

### BACKGROUND

For decades consumers have enjoyed the automation of dozens of chores with the use of various appliances. Generally, in Western society, performing chores like washing dishes or clothes by hand is a thing of the past. While manufacturers continue to offer new features to enhance these time- and labor-saving appliances, it is still frequently necessary for consumers to physically engage the appliances to effectively control them or learn the status of a task being performed. This becomes particularly burdensome to the consumer if the consumer is otherwise occupied. For example, if a consumer seated in one room in a house watching television while an appliance is washing clothes in another room, the consumer may need to interrupt his or her viewing to check whether the washing has been completed. In another example, the user who is otherwise occupied may wish to start preheating of an oven or turn the oven off after a prescribed time or under pre-defined conditions.

### SUMMARY

An appliance control system includes a user electronic computing device including a first processor and a first memory. A display is operatively coupled with the user electronic computing device to present, to a user, appliance data managed by the user electronic computing device. A first transceiver is configured to send signals from and receive signals at the user electronic computing device. An appliance electronic computing device including a second processor and a second memory is operatively coupled with an appliance configured to perform actions described by data from the appliance electronic computing device. A second transceiver is configured to send signals from and receive signals at the appliance electronic computing device. A user interface component is operatively coupled with the user electronic computing device and configured to process appliance responses for presentation to the display and prepare user command packages from user input. An appliance controller is operatively coupled with the appliance electronic computing device and configured to manage translation of commands to the appliance and issuance of responses from the appliance. A user remote control is configured for making selections of appliance data from the user electronic computing device and making selections of commands for issuing to the appliance controller.

A method for controlling an appliance includes presenting a user console including at least one command initiator to a display; with a remote control, selecting at least one command initiator; with a first processing device, in response to selecting at least one command initiator, issuing an appliance control command; transmitting a first wireless communication packet including the appliance control command directly to a appliance electronic computing device; forwarding the appliance control command to the appliance; and performing, by the appliance, one or more actions corresponding with the appliance control command.

A computer program product for enabling appliance control through a display includes a non-transitory computer readable storage medium having program instructions encoded thereon. Instructions include first program instructions executable by a electronic computing device to cause presentation of a user console including at least one command initiator to a display; second program instructions executable by a electronic computing device to cause issuance of an appliance control command in response to selecting at least one command initiator with a remote control; third program instructions executable by a electronic computing device to cause transmission of a first wireless communication packet including the appliance control command directly to a remote electronic computing device; fourth program instructions executable by a electronic computing device to cause forwarding of the appliance control command to an appliance coupled with the remote electronic computing device; fifth program instructions executable by a electronic computing device to cause receipt of an appliance state response from the appliance; sixth program instructions executable by a electronic computing device to cause transmission of a second wireless communication packet including the appliance state response directly to the first processing device; and seventh program instructions executable by a electronic computing device to cause presentation of the appliance state response to the display using the user console.

### BRIEF DESCRIPTION OF THE FIGURES

FIG. 1 illustrates a high level overview schematic of an example appliance control system 1000.

FIG. 2 illustrates a high level block diagram of two communicating electronic computing devices usable with the example appliance control system of FIG. 1.

FIG. 3 illustrates a high level block diagram of a user interface component useable with the example appliance control system of FIG. 1.

FIG. 4 illustrates a high level block diagram of an appliance controller usable with the example appliance control system of FIG. 1.

FIG. 5 illustrates a high level block diagram of protocol stacks useable with the example appliance control system of FIG. 1.

FIG. 6 illustrates a block diagram of an example user console useable with the example appliance control system of FIG. 1.

FIG. 7 illustrates a block diagram of an example data structure formed according to a redundant discovery protocol and usable with the example appliance control system of FIG. 1.

FIG. 8 illustrates a flow diagram of an example user command process of an appliance control method.

FIG. 9 illustrates a flow diagram of an example appliance response process of an appliance control method.

### DETAILED DESCRIPTION

Known methods for controlling and monitoring appliances in the home rely on human interaction with appliance. Appliances and equipment in the home cannot presently be monitored or controlled using television interface or television remote control. If given this ability, consumers may avoid the unnecessary disruption of having to get up and check on the appliances.

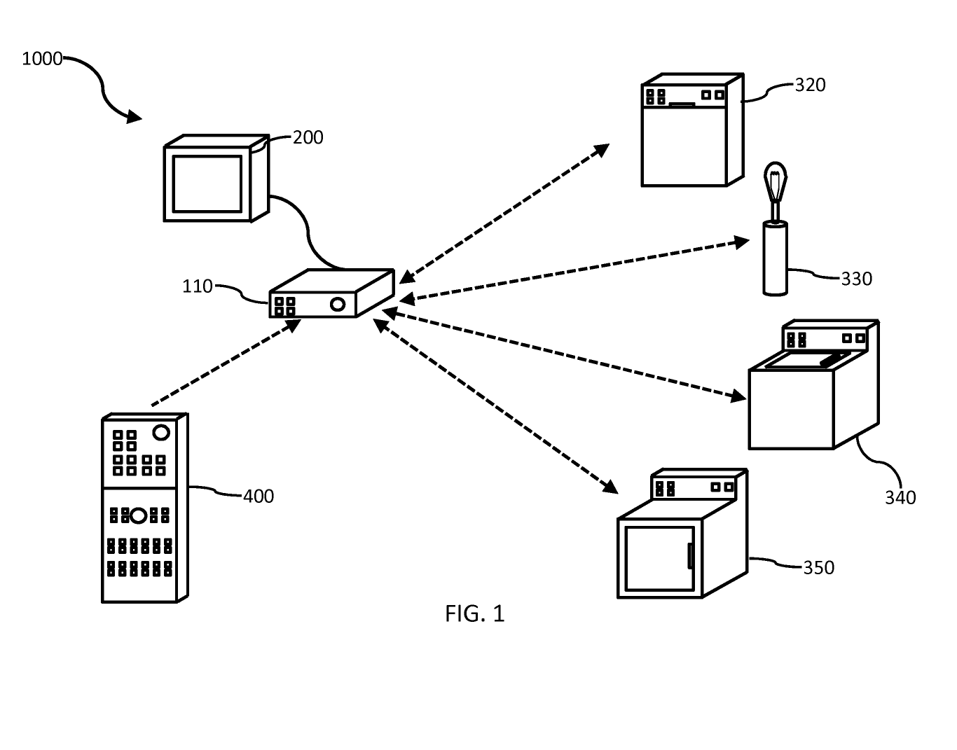

In the example system 1000 illustrated in FIG. 1, computing device 110 is coupled with television or display 200 to provide data for display thereon. In some examples, computing device 110 and television or display 200 may be provided as one component in a single housing. Computing device 110 is capable of receiving signals from user remote 400 to change screens or pages within a user console and, using the console, issue appliance commands and review appliance responses including appliance state information.

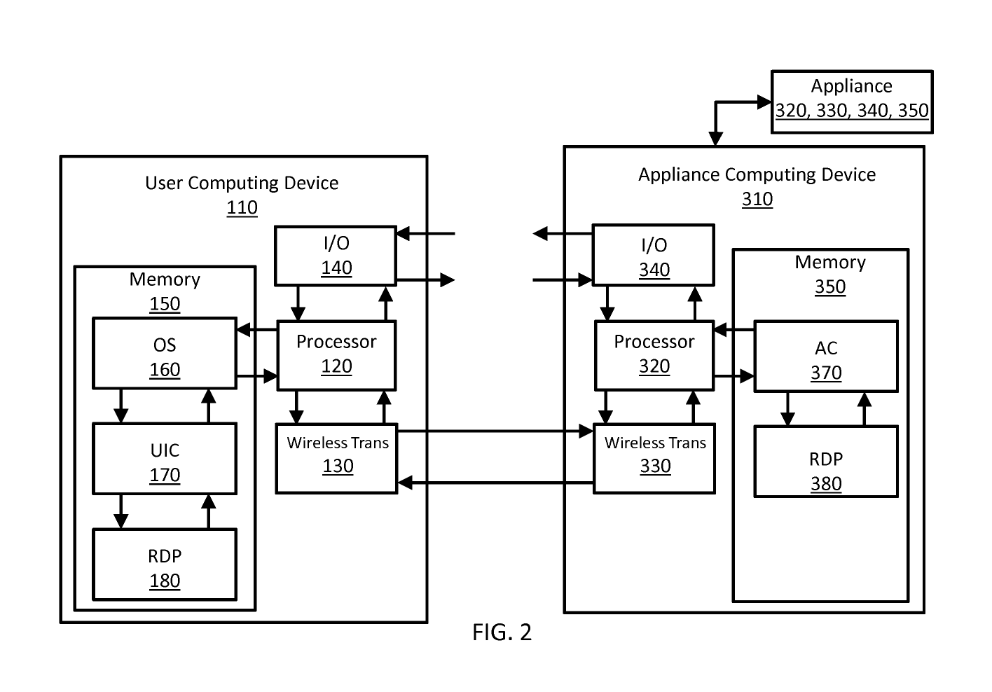

An appliance 320, 330, 340, 350 is operatively coupled with appliance electronic computing device 310 (FIG. 2) to perform actions, services or tasks described by data forwarded by appliance electronic computing device 310 from user electronic computing device 110. While FIG. 1 illustrates a dishwasher 320, a lamp 330, a clothes washer 340 and a clothes dryer 350, any of a variety of household utility appliances may be a part of system 1000 and may be controlled through interaction with device 100 in combination with user remote 400 and display 200.

As illustrated by way of example in FIG. 2, electronic computing devices 110 and 310 may include processors 120 and 320, wireless transceivers 130 and 330, input/output devices 140 and 340 and memories 150 and 350.

Processors 120 and 320 may be any devices capable of executing computer readable program code stored in memories 150 and 350. Example processors for use as processors 120 and 130 include but are not to ARM, MIPS, AVR, PIC, MCS-51 and Z80.

First wireless transceiver 130 is configured to send signals from and receive signals at electronic computing device 110 while second wireless transceiver 330 is configured to send signals from and receive signals at appliance electronic computing device 310. Transceivers 130 and 330 may be configured to send signals there between as illustrated in FIG. 2. In some embodiments, rather than a local area network or a wide area network requiring the use of one or more routers, the wireless communication used with system 1000 is a peer-to-peer, dedicated, or ad-hoc direct network such as a personal area network (PAN) between the user electronic computing device 110 and the appliance electronic computing device 310 in a loose client-server relationship. Such a PAN may be created out of any of a variety of wireless technologies including but not limited to Bluetooth.

In some embodiments, use of a local area network or a wide area network or both may be desirable and system 1000 may be configured to include one or both of these.

Input/output interface 140 operatively couples display 200 with electronic computing device 110 through processor 120 to enable presentation of output data from electronic computing device 100 to a user.

Input/output interfaces 140 and 340 may include but are not limited to keyboards, pointing devices, gesture interpreting devices, touchscreens and other displays, printers, and audio speakers which are capable of operative coupling to the devices 110 and 310 either directly or through intervening I/O.

In some embodiments, I/O interfaces 140 and 340 of devices 110 and 310 may further include software, hardware, etc. for transmitting and receiving information according to the mobile phone mobile communications standards 3G or 4G. For example, devices 110 and 310 may enable UMTS, mobile WiMAX, Long Term Evolution, CDMA200, W-CDMA and TD-SCDMA.

A display 200, which may be in the form of a television, is operatively coupled with the user electronic computing device 110 to present, to a user, appliance data from user electronic computing device 110 including appliance state information and other appliance responses.

As memories 150 and 350, any combination of one or more computer readable mediums may be used. The computer readable medium may be a computer readable storage medium or a computer readable signal medium.

Computer readable storage mediums usable within the devices 110 and 310 may include but are not limited to electronic, magnetic, optical, electromagnetic, infrared, or semiconductor systems, apparatuses, or devices, or any suitable combination thereof. Specific examples include but are not limited to electrical connections having one or more wires; portable computer diskettes; hard disks; random access memories (RAM); read-only memories (ROM); erasable, programmable read-only memories (EPROM or Flash memory); optical fibers; portable compact disc read-only memories (CD-ROM); optical storage devices; magnetic storage devices; and combinations thereof. In the context of this disclosure, a computer readable storage medium may be any tangible, non-transitory medium capable of containing, or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical or a combination thereof. A computer readable signal medium may be any computer readable medium that is not a computer readable storage medium and that can communicate, propagate, or transport a program for use by or in connection with an instruction execution system, apparatus, or device.

Stored within memory 150 is an operating system 160, a user interface component 170 and redundant discovery protocol constructor 180. Stored within memory 350 is an appliance controller 370 in communication with a redundant discovery protocol constructor 380. While device 310 is illustrated as including a memory 350 without an operating system, some example appliance control systems may include an operating system on electronic computing device 310. While illustrated as being an object stored in memory 150 separately from user interface component 170, in some embodiments, redundant discovery protocol constructor 180 may be contained within user interface component 170. Similarly, in some embodiments, redundant discovery protocol 380 may be contained within appliance controller 370.

A user interface component 170 is operatively coupled with user electronic computing device 110 and configured to process appliance responses and other appliance information for presentation to display 200 as well as to prepare user command packages from user input provided through remote control 400 using user console 600. In some embodiments, a user graphics generator 172 is configured to present user console 600, populated with various appliance information, to the television or display 200 and a command encoder 174 is configured to assemble user command selections with an appliance identifier in a user command package described below.

An appliance controller 370 is operatively coupled with appliance electronic computing device 310 and configured to manage translation of commands sent to appliance 320, 330, 340, 350 as well as manage issuance of responses from appliance 320, 330, 340, 350. In some embodiments, a command decoder 372 is configured to decode command data from user command packages and forward the command data to the appliance 320, 330, 340, 350 and an appliance response encoder 376 is configured to package responses from the appliance 320, 330, 340, 350 for transmission to user interface component 170.

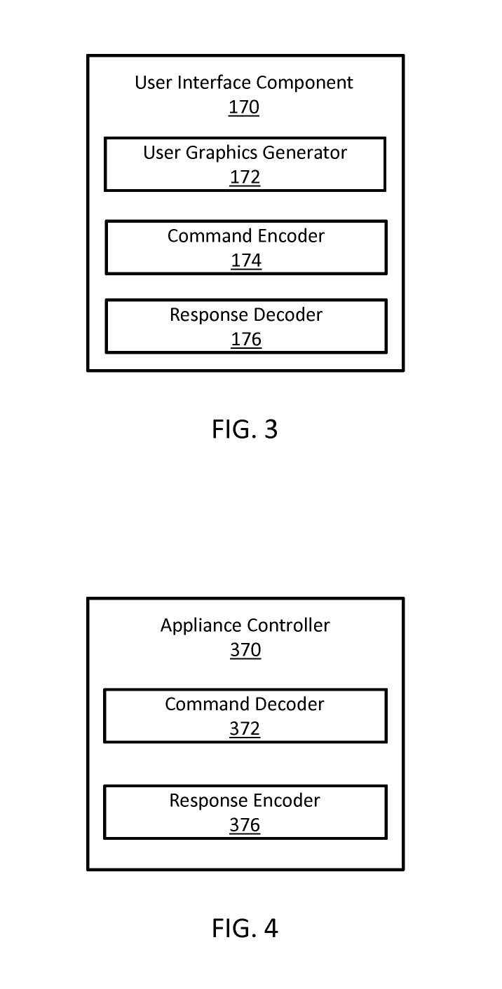

It should be understood that each component illustrated in FIGS. 3 & 4, and combinations thereof are capable of implementation by computer readable program code in the form of instructions. These instructions may be provided to a processing devices such as 120 and 320 which may be components of general purpose computing device system, special purpose computing device system, or other programmable data processing apparatuses to produce a machine, such that the instructions, which execute via processing devices 120 and 320 of devices 110 and 310 or other programmable data processing apparatus, create means for implementing functions of the components.

The computer readable program code in the form of instructions may also be stored in a computer readable medium that can direct a computing device system or other programmable data processing apparatus such that the instructions produce an article of manufacture including instructions which implement functions components.

Computer program code included within operating system 160, user interface component 170, appliance controller 370 and redundant protocol constructors 180 and 380 and capable of carrying out operations for aspects of appliance control may be written in any combination of one or more programming languages, including an object oriented programming language such as Java, Smalltalk, C++, C# or the like and conventional procedural programming languages, such as the “C” programming language or similar programming languages.

The program code may execute entirely on the users computing device system, partly on the users computing device system, or entirely on a remote computer or server connected to the user's computing device system through any type of network, including a Wireless Personal Area Network (WPAN), a local area network (LAN) or a wide area network (WAN). Alternatively, the connection may be made to an external computing device system through the Internet using an Internet Service Provider.

Further, program code embodied on a computer readable medium may be transmitted using any appropriate medium, including but not limited to wireless, wireline, optical fiber cable, RF or any combination of these.

Electronic computing devices 110 and 310 may be any devices capable of executing computer readable program code stored in memories 150 and 350 including by not limited to a desktop computer, a laptop computer, a tablet computer, a personal digital assistant or a smartphone. In particular, user electronic computing device may be in the form of a set-top box or may be contained within the television or display 200.

Electronic computing device 310 may be an internal component of an appliance such as dishwasher 320, lamp 330, clothes washer 340 or clothes dryer 350, or it may be provided as an external device operatively coupled with an appliance.

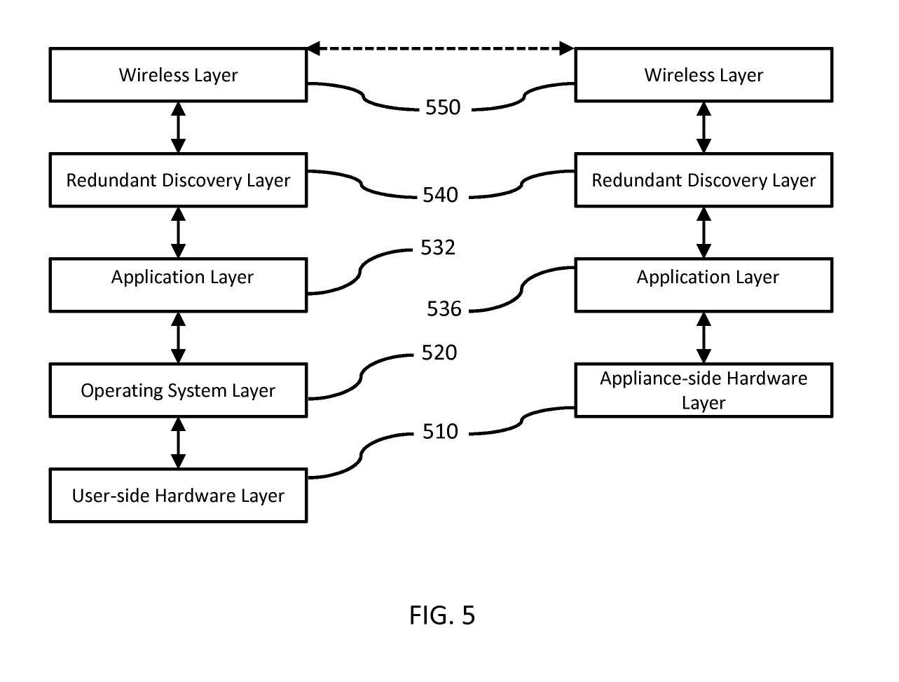

FIG. 5 illustrates a high level block diagram protocol stacks useable with the example appliance control system 1000. On the user side, hardware passes instructions at a hardware layer 510 which instructions may be encoded within operating system data structures usable at the operating system layer 520. In turn, at application layer 532, data structures are manipulated which encode data structures from operating system layer 520. Application layer data structures are encoded by data structures at redundant discovery layer 540. Finally, redundant discovery layer data structures are encoded at wireless layer 550 for transmission in a wireless protocol.

After transmission, wireless communication packets are decoded in a manner similar to the reverse of the process of encoding. A wireless communication packet at the wireless layer 550 is decoded to yield a data structure at the redundant discovery protocol layer 540, which is decoded to yield a data structure at application layer 536 which is finally decoded to yield a data structure at appliance side hardware layer 510.

As illustrated by way of example in FIG. 5, the user side application layer 532 is different from the appliance side application layer 536. However, in some example appliance control systems, these application layers may be identical or substantially identical.

A user remote control 400 (FIG. 1) is configured for making selections of appliances within system 1000 as well as appliance data held by a memory coupled with user electronic computing device 110 from a user console presented on display or television 200. User remote control 400 also enables making selections of commands for issuing to appliance controller 370 according to icons or input boxes or other command initiators presented in a user console. In some embodiments, user remote control 400 is configured to make selections wirelessly. Wireless selection may be enabled by any of a variety of wireless communication protocols including but not limited to infra-red, Bluetooth or WiFi.

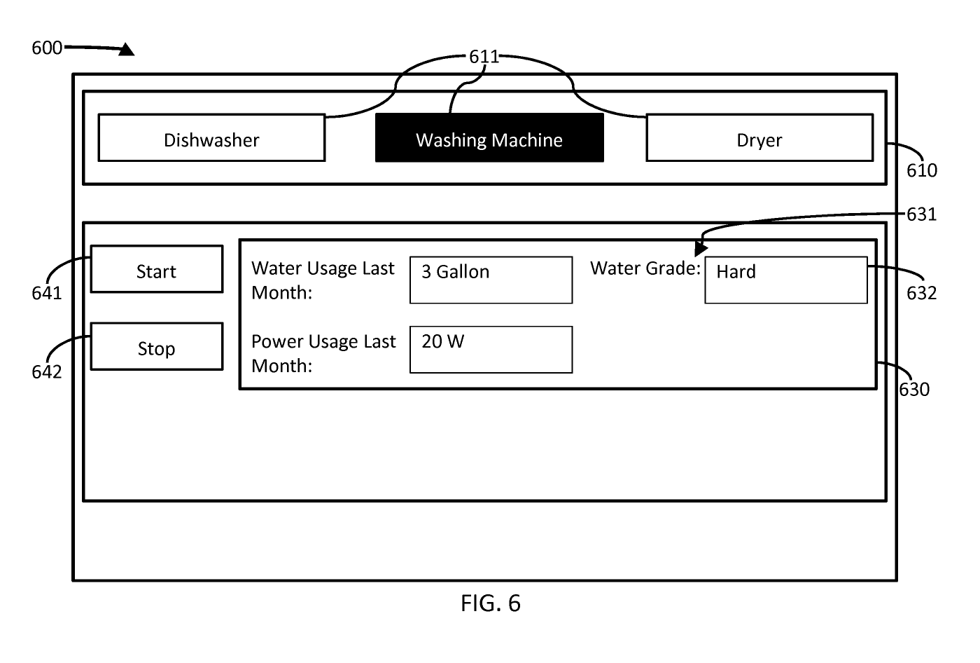

An example graphical user console page or screen 600 is illustrated in FIG. 6. A header widget 610 contains a number of icon buttons 611 enabling selection of an appliance the user wishes to control or receive state information from. As illustrated in FIG. 6, a user has selected the washing machine button and is presented with information about the washing machine appliance in widget 630 which includes various measures of the appliance's performance, operating conditions and other state information. State headers 631 may be provided to label state information in boxes 632. To enable starting and stopping of the selected washing machine appliance, a user may select buttons 641 and 642, respectively to initiate a command for transmission to the washing machine.

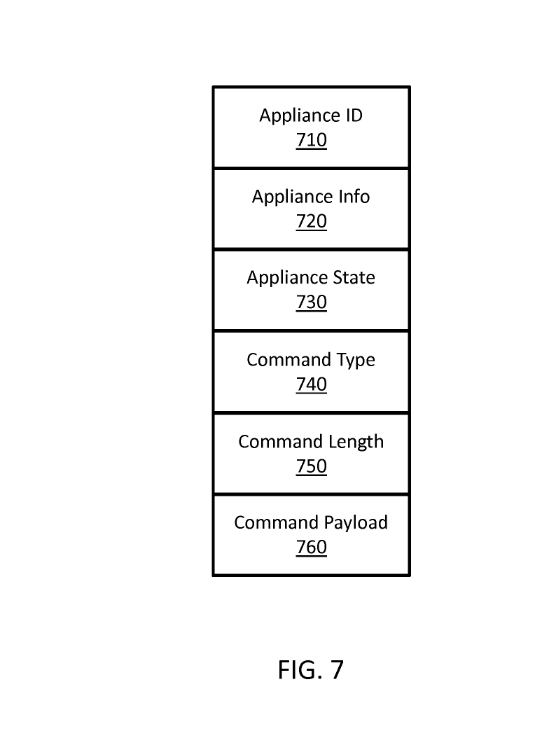

Illustrated by way of example in FIG. 7, a user command package constructed in accordance with a redundant discovery protocol by redundant discovery protocol constructor 380 includes an appliance identifier 710, appliance information 720, current appliance state 730, appliance control command type 740, appliance control command data length 750 and appliance control command data/payload 760 components.

A packaged appliance response assembled in accordance with redundant discovery protocol 180 have an analogous construction to the example packaged appliance response illustrated in FIG. 7 and include appliance identification, appliance information, current appliance state, command type, command data length and command data components. To avoid unnecessary repetition, packaged appliance responses are not explicitly illustrated.

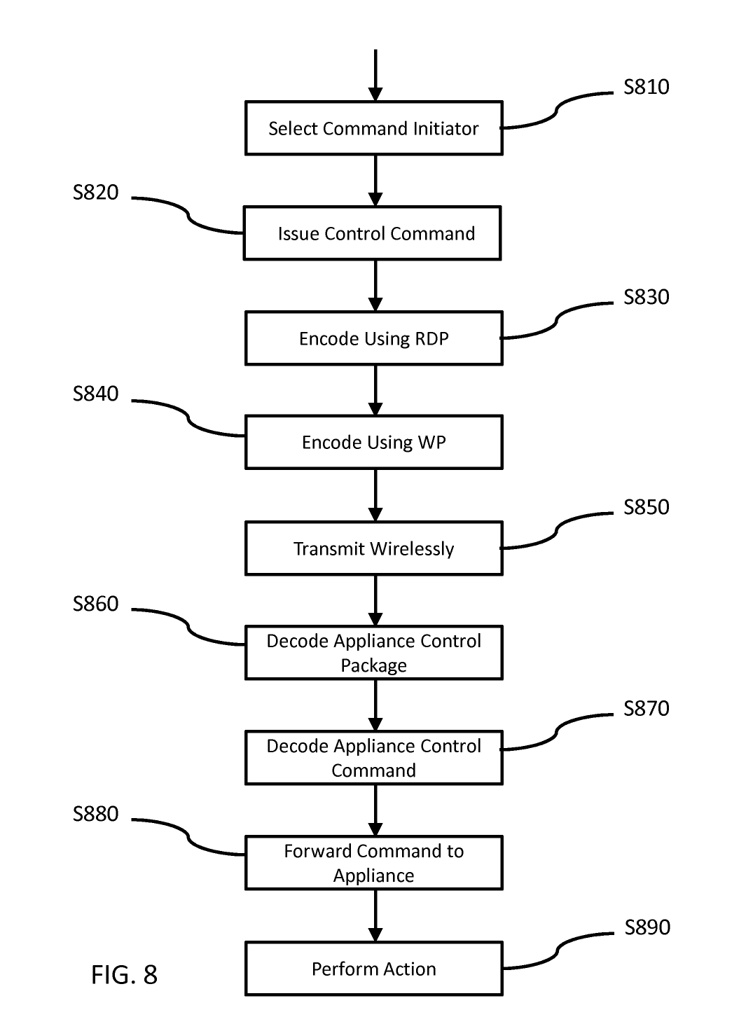

An example method for controlling an appliance is depicted by flow diagrams in FIGS. 8 & 9.

FIG. 8 illustrates a flow diagram of an example user command process of an appliance control method.

In order to begin controlling an appliance with system 1000, the system is first assembled and configured including assembly of any hardware components and installation of any software components on respective hardware components. For example, a user couples a user electronic computing device 110 hosting user interface component 170 to a television or display 200 and couples appliance electronic computing 310 device hosting appliance controller 370 to an appliance to be controlled, monitored or both. In embodiments wherein user electronic computing device 100 is integral with television or display 200 and/or appliance electronic computing device 310 is integral with the appliance to be controlled or monitored, it will be unnecessary for the user to perform the coupling. With any physical assembly completed, wireless transceivers 130 and 300 are configured for two-way communication to enable sending and receiving of packaged appliance commands and packaged appliance responses.

After assembly, configuration and installation, an initialization process may facilitate population of identifying characteristics, initial state and other appliance information into fields of a data object accessible by user interface controller 170.

With any necessary initialization processes completed, system 1000 presents a user console through input/output interface 140 of device 110. In some examples, the console is presented to a display 200. In some examples, a home or main screen is provided as the start-up screen for system 1000. From this home or main screen a user may navigate through a number of pages or screens facilitating review of appliance states and control of appliance states and actions.

To begin controlling an appliance, a user first selects which appliance he or she would like to control and system 1000 presents, a page or screen pertaining to the selected appliance. The page or screen including at least one command initiator.

With a remote control the user selects at least one command initiator in step S810 by depressing or otherwise manipulating one or more buttons, knobs or dials which may be physical or virtual. The users selection is received through Input/Output interface 140 and delivered by processor 120 to operating system 160 which, in turn, delivers the selection to user interface controller 170.

User interface controller 170 issues an appliance control command in step S820.

With an appliance control command issued, command encoder 174 converts the appliance control command into a user command package (FIG. 7) according to a redundant discovery protocol in step S830.

With the appliance control command converted into a user command package, a wireless communication driver (not illustrated) encodes the appliance control package within a user wireless communication packet according to a wireless protocol in step S840.

The user wireless communication packet including the appliance control command is transmitted wirelessly directly to appliance electronic computing device 310 in step S850.

The user wireless communication packet is next decoded by a wireless communication driver (not illustrated) according to the wireless protocol to yield an appliance control package in step S860.

The user command package is finally decoded by command decoder 372 according to the redundant discovery protocol to yield an appliance control command in step S870.

Appliance controller 370 next forwards the appliance control command to the appliance in step S880 and the appliance performs one or more actions, tasks or services described by the appliance control command in step S890. For example, a user may have selected a command initiator from user console 600 with the intention of starting a dishwasher 320. Thus, with the “start” command forwarded to dishwasher 320, dishwasher 320 begins washing previously loaded dishes.

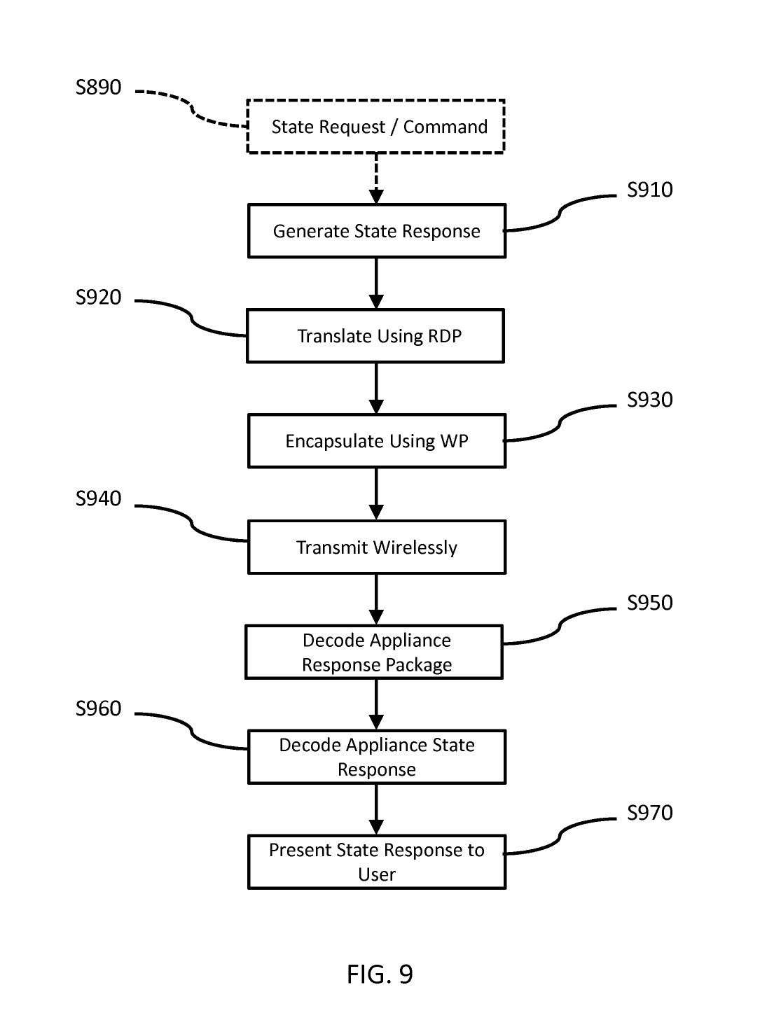

FIG. 9 illustrates a flow diagram of an example appliance response process of an appliance control method.

With system 1000 assembled, configured, installed and initialized as described above, an appliance 320, 330, 340 or 350 may generate a response in step S910. The response may be a response to a state inquiry command about performance or operating condition of an appliance or may be a response to an initialization request forwarded through appliance device 310 from user device 110. After completing an action, an appliance within system 1000 may provide a compliance response which may include information identical or similar to that provided with a state response. In some circumstances, the action commanded by a user may simply be generation of an application response to enable discovery of appliance performance, operating conditions or state. The stimulus for generating a state response, S890, is illustrated in FIG. 9 in broken lines as being a step of a previously described method.

With a response generated, the appliance response is assembled into an appliance response package by appliance response encoder 376 according to the redundant discovery protocol in step S920.

Next, the appliance response package is encoded within an appliance wireless communication packet by a wireless communication driver (not illustrated) according to the wireless protocol in step S930.

With an appliance wireless communication packet constructed, the wireless communication package including the appliance state response is transmitted directly to the user processing device in step S940.

Upon receiving the wireless communication package from device 310 through processor 120, a wireless communication driver decodes the appliance response package from the appliance wireless communication packet according to the wireless protocol in step S950. Subsequently, response decoder 176 decodes the appliance response package according to the redundant discovery protocol to yield the appliance state response in step S960.

Finally, the appliance state response is presented to a display by populating widgets of a console page or screen using graphics generator 172 in step S970.

The processes and steps depicted by way of example in the flowchart illustrations of FIGS. 8 & 9 may be implemented by a computing device system or other programmable data processing apparatus interpreting and executing instructions stored as computer readable program code on one or more computer readable storage mediums or one or more computer readable signal mediums. Each block in the flowchart illustrations may represent a module, segment, or portion of computer readable program code, which comprises one or more executable instructions for implementing the depicted logical function(s). It should also be noted that, in some alternative implementations, the functions noted in the block may occur out of the order noted in the flowchart illustrations. For example, two blocks shown in succession may, in fact, be executed substantially concurrently, or the blocks may sometimes be executed in the reverse order, depending upon the functionality involved. It should also be noted that each block of the flowchart illustrations, can be implemented by special purpose hardware-based systems that perform the specified functions or acts, or combinations of special purpose hardware and computer executable instructions.

For example, a computer program product for enabling appliance control through a display, may include a non-transitory computer readable storage medium having encoded thereon a series of instructions. A first set of program instructions, upon execution by an electronic computing device, are capable of causing presentation of a user console to a display. As described above, the console may include including one or more command initiators. A second set of program instructions, upon execution by an electronic computing device, are capable of causing issuance of an appliance control command in response to a user selecting at least one command initiator with a remote control. A third set of program instructions, upon execution by a computing device, are capable of causing transmission of, directly to a remote electronic computing device, a first wireless communication packet including an appliance control command.

A fourth set of program instructions, upon execution by an electronic computing device, is capable of causing forwarding of the appliance control command to an appliance coupled with the remote electronic computing device. A fifth set of program instructions, upon execution by an electronic computing device are capable of causing receipt of an appliance state response from the appliance. A sixth set of program instructions, upon execution by an electronic computing device, are capable of causing transmission of, directly to the first processing device, a second wireless communication packet including the appliance state response. Additionally, a seventh set program instructions, upon execution by an electronic computing device, are capable of causing presentation of the appliance state response to the display through the user console.

Furthermore, the processes depicted in FIGS. 8 & 9 may be performed in any order and may be performed in alternating fashion for any number of iterations conducive to facilitating appliance control and appliance state monitoring by a user. For example, the process of FIG. 9 may be performed and then the process of FIG. 8 may be performed or vice versa.

While the disclosure has been presented with respect to certain specific embodiments, it will be appreciated that many modifications and changes may be made by those skilled in the art without departing from the spirit and scope of the invention. It is intended, therefore, by the appended claims to cover all such modifications and changes as fall within the true spirit and scope of the disclosure.

What is claimed is:

1. An appliance control system, comprising:
a user electronic computing device including a first processor and a first memory;
a display operatively coupled with the user electronic computing device to present, to a user, appliance data managed by the user electronic computing device;
a user transceiver configured to send signals from and receive signals at the user electronic computing device;
an appliance electronic computing device in communication with the user electronic computing device and remote therefrom, the appliance electronic computing device including a second processor and a second memory;
an appliance operatively coupled with the appliance electronic computing device to perform actions described by data from the appliance electronic computing device;
a second transceiver configured to send signals from and receive signals at the appliance electronic computing device;
a user interface component operatively coupled with the user electronic computing device and configured to process appliance responses for presentation to the display and prepare user command packages from user input;
an appliance controller operatively coupled with the appliance electronic computing device and configured to manage translation of commands to the appliance and issuance of responses from the appliance; and
a user remote control configured for making selections of appliance data from the user electronic computing device and making selections of commands for issuing to the appliance controller.

2. The appliance control system of claim 1, wherein the first and second transceivers are configured to send and receive signals wirelessly without an intermediate device.

3. The appliance control system of claim 3, wherein the user remote control is configured to make selections wirelessly.

4. The appliance control system of claim 1, wherein the user command packages include appliance identification, appliance information, current appliance state, command type, command data length and command data components.

5. The appliance control system of claim 1, wherein the user interface component further comprises a user graphics generator configured to present a user console including one or more user command initiators.

6. The appliance control system of claim 1, wherein the user interface component further comprises a command encoder configured to assemble user command selections with an appliance identifier in a user command package.

7. The appliance control system of claim 7, wherein the appliance controller further comprises a command decoder configured to decode command data from the user command packages and send the command data to the appliance.

8. The appliance control system of claim 1, wherein the appliance controller further comprises an appliance response encoder configured to package responses from the appliance for transmission to the user interface component.

9. The appliance control system of claim 8, wherein the packaged appliance responses include appliance identification, appliance information, current appliance state, command type, command data length and command data components.

10. A method for controlling an appliance, comprising:
presenting a user console including at least one command initiator to a display;
with a remote control, selecting at least one command initiator;
with a first processing device, in response to selecting at least one command initiator, issuing an appliance control command;
transmitting a first wireless communication packet, including the appliance control command, from the first processing device directly to a second processing device remote from the first processing device;
forwarding the appliance control command to the appliance; and
performing, by the appliance, one or more actions corresponding with the appliance control command.

11. The method for controlling an appliance as set forth in claim 10, further comprising:
translating the appliance control command into an appliance control package according to a redundant discovery protocol.

12. The method for controlling an appliance as set forth in claim 11, further comprising:
encoding the appliance control package within the first wireless communication packet according to a wireless protocol.

13. The method for controlling an appliance as set forth in claim 10, further comprising:
parsing an appliance control package from the first wireless communication packet according to the wireless protocol.

14. The method for controlling an appliance as set forth in claim 13, further comprising:
parsing the appliance control command from the appliance control package according to the redundant discovery protocol.

15. The method for controlling an appliance as set forth in claim 10, further comprising:
generating, by the appliance, an appliance state response;
transmitting a second wireless communication packet including the appliance state response directly to the first processing device; and
presenting the appliance state response to the display.

16. The method for controlling an appliance as set forth in claim 15, further comprising:
translating the appliance state response into an appliance response package according to the redundant discovery protocol.

17. The method for controlling an appliance as set forth in claim 16, further comprising:
encoding the appliance response package within the second wireless communication packet according to the wireless protocol.

18. The method for controlling an appliance as set forth in claim 17, further comprising:
parsing an appliance response package from the second wireless communication packet according to the wireless protocol.

19. The method for controlling an appliance as set forth in claim 18, further comprising:
parsing the appliance state response from the appliance response package according to the redundant discovery protocol.

20. A computer program product for enabling appliance control through a display, the program product comprising:
a non-transitory computer readable storage medium having encoded thereon:
first program instructions executable by a electronic computing device to cause presentation of a user console including at least one command initiator to a display;
second program instructions executable by a electronic computing device to cause issuance of an appliance control command in response to selecting at least one command initiator with a remote control;
third program instructions executable by a electronic computing device to cause transmission of a first wireless communication packet including the appliance control command directly to a remote electronic computing device;
fourth program instructions executable by a electronic computing device to cause forwarding of the appliance control command to an appliance coupled with the remote electronic computing device;
fifth program instructions executable by a electronic computing device to cause receipt of an appliance state response from the appliance;
sixth program instructions executable by a electronic computing device to cause transmission of a second wireless communication packet including the appliance state response directly to the first processing device; and
seventh program instructions executable by a electronic computing device to cause presentation of the appliance state response to the display using the user console.
